(19) United States
(12) Patent Application Publication
(10) Pub. No.: US 2025/0190980 A1
(43) Pub. Date: Jun. 12, 2025

(54) POINT OF SALE SYSTEM, CUSTOMER DISPLAY, AND METHOD FOR ACQUIRING A SIGNATURE OF A CUSTOMER

(71) Applicant: LABAU Technology Corp., New Taipei City (TW)

(72) Inventor: Jehng-Huei CHEN, New Taipei City (TW)

(21) Appl. No.: 18/968,262

(22) Filed: Dec. 4, 2024

(30) Foreign Application Priority Data
Dec. 6, 2023 (TW) 112213311

(51) Int. Cl. G06Q 20/38; G06Q 20/20

(52) U.S. Cl. CPC G06Q 20/3825; G06Q 20/202

(57) ABSTRACT

A point of sale (POS) system for acquiring a signature of a customer, includes a POS terminal and a customer display. The customer display includes a touchscreen, and a processing module that is electrically connected to the touchscreen and the POS terminal. The processing module is configured to control the touchscreen to display a signing area during a signature acquisition procedure, and control the touchscreen to allow the customer to perform a signing operation on the signing area. The processing module is further configured to control the touchscreen to detect touch points on the touchscreen and to generate multiple detecting signals that are related respectively to the touch points as the signing operation is being performed on the signing area of the touchscreen. The processing module is further configured to generate signature data based on the detecting signals, and to transmit the signature data to the POS terminal.

### CROSS-REFERENCE TO RELATED APPLICATION

This application claims priority to Taiwanese Utility Model Patent Application No. 112213311, filed on Dec. 6, 2023, the entire disclosure of which is incorporated by reference herein.

### FIELD

The disclosure relates to a point of sale (POS) system, a customer display, and a method for acquiring a signature of a customer.

### BACKGROUND

A point of sale (POS) terminal of a POS system is typically installed in a physical store, and is used for processing checkouts, recording transaction records and revenues, etc. Sometimes, a signature of a customer is required by the POS terminal at a time of a transaction. In order to obtain the signature of the customer, a conventional POS system needs to include an additional signature pad connected to a POS terminal of the conventional POS system for the customer to sign on.

### SUMMARY

Therefore, an object of the disclosure is to provide a point of sale (POS) system, a customer display, and a method for acquiring a signature of a customer that can alleviate at least one of the drawbacks of the prior art.

According to an aspect of the disclosure, the POS system includes a POS terminal and a customer display. The customer display includes a touchscreen, and a processing module that is electrically connected to the touchscreen and the POS terminal. The processing module is configured to control the touchscreen to display a signing area on the touchscreen during a signature acquisition procedure for acquiring a signature of the customer, and to control the touchscreen to allow the customer to perform a signing operation on the signing area. The processing module is further configured to control the touchscreen to detect touch points on the touchscreen, and generate multiple detecting signals that are related respectively to the touch points as the signing operation is being performed by the customer on the signing area of the touchscreen. The processing module is further configured to generate signature data based on the detecting signals that are generated by the touchscreen during the signature acquisition procedure, and to transmit the signature data to the POS terminal.

According to another aspect of the disclosure, the customer display is to be used in a POS system for acquiring a signature of a customer. The POS system includes a POS terminal. The customer display includes a touchscreen and a processing module. The processing module is electrically connected to the touchscreen and is adapted to be electrically connected to the POS terminal. The processing module is configured to control the touchscreen to display a signing area on the touchscreen during a signature acquisition procedure for acquiring a signature of the customer, and to control the touchscreen to allow the customer to perform a signing operation on the signing area. The processing module is further configured to control the touchscreen to detect touch points on the touchscreen, and generate multiple detecting signals that are related respectively to the touch points as the signing operation is being performed by the customer on the signing area of the touchscreen. The processing module is further configured to generate signature data based on the detecting signals that are generated by the touchscreen during the signature acquisition procedure, and to transmit the signature data to the POS terminal.

According to yet another aspect of the disclosure, the method for acquiring a signature of a customer is to be implemented by a POS system that includes a POS terminal and a customer display. The customer display includes a touchscreen and a processing module. The method includes: the processing module controlling the touchscreen to display a signing area on the touchscreen during a signature acquisition procedure for acquiring a signature of the customer, and controlling the touchscreen to allow the customer to perform a signing operation on the signing area; the processing module controlling the touchscreen to detect touch points on the touchscreen, and to generate multiple detecting signals that are related respectively to the touch points as the signing operation is being performed by the customer on the signing area of the touchscreen; the processing module generating signature data based on the detecting signals that are generated by the touchscreen during the signature acquisition procedure; and the processing module transmitting the signature data to the POS terminal.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram of a point of sale (POS) system according to an embodiment of the present disclosure.

FIG. 2 is a flow chart illustrating a method for acquiring a signature of a customer according to an embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

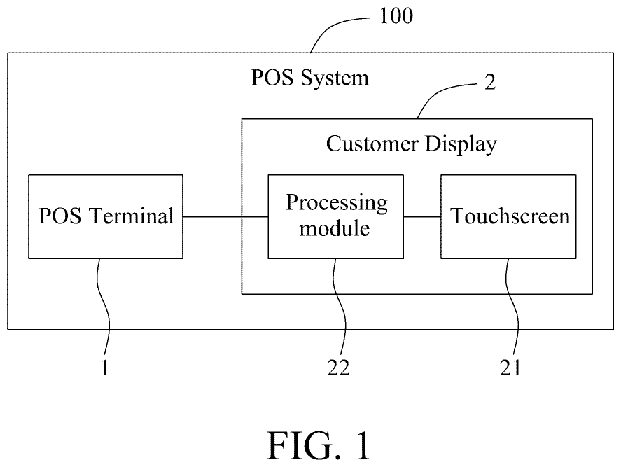

Referring to FIG. 1, a point of sale (POS) system 100 according to an embodiment of the present disclosure is provided. The POS system 100 includes a POS terminal 1 and a customer display 2.

In this embodiment, the POS terminal 1 is installed with an operating system provided by Microsoft® and POS applications. However, the operating system and the POS applications are not limited to such.

The customer display 2 includes a touchscreen 21, and a processing module 22 that is electrically connected to the touchscreen 21 and the POS terminal 1. The processing module 22 may include, for example, but is not limited to, a microcontroller unit (MCU). In this embodiment, the processing module 22 is electrically connected to the POS terminal 1 through an interface in compliance with Universal Serial Bus (USB). However, the way the processing module 22 is connected to the POS terminal 1 is not limited to such.

In this embodiment, the POS terminal 1 transmits purchase information that is related to a purchase to be made by a customer to the processing module 22. In response to receipt of the purchase information from the POS terminal 1, the processing module 22 controls the touchscreen 21 to display the purchase information on the touchscreen 21 for viewing by the customer. The purchase information includes, for example, names of one or more goods, unit prices of the one or more goods, and a total price for the purchase to be made by the customer. In other embodiments, the processing module 22 may control the touchscreen 21 to further display other types of content. For example, the processing module 22 may control the touchscreen 21 to display welcoming messages, advertisements, and event announcements, but the content that may be displayed by the touchscreen 21 is not limited to these. That is to say, a merchant may determine, according to the needs of the merchant, the content to be displayed on the touchscreen 21.

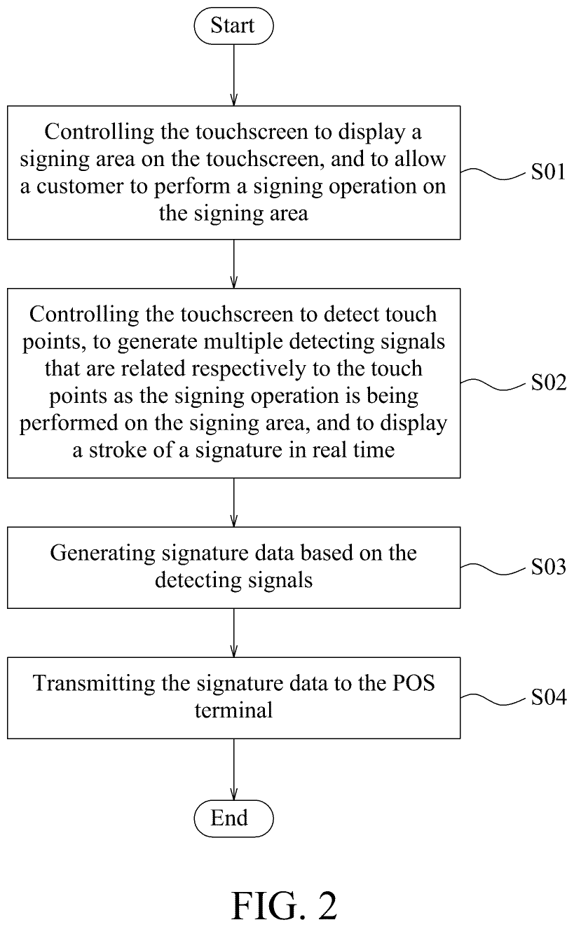

Referring to FIGS. 1 and 2, a method for acquiring a signature of the customer will be described in detail below. For example, the method will be implemented when a signature of the customer is required to complete the purchase. The method includes steps S01 to S04.

In step S01, the processing module 22 controls the touchscreen 21 to display a signing area on the touchscreen 21 during a signature acquisition procedure for acquiring a signature of the customer, and controls the touchscreen 21 to allow the customer to perform a signing operation on the signing area. The signing operation may be performed by the customer, using a fingertip or a stylus pen to make contact with the touchscreen 21, and to sign his/her signature on the signing area while maintaining contact with the touchscreen 21; however, the disclosure is not limited to thus.

In step S02, the processing module 22 then controls the touchscreen 21 to detect touch points (i.e., locations on the touchscreen 21 where the fingertip of the customer or the stylus pen makes contact with the touchscreen 21) on the touchscreen 21, and to generate multiple detecting signals that are related respectively to the touch points as the signing operation is being performed by the customer on the signing area. The processing module 22 further controls the touchscreen 21 to display in real time, based on the detecting signals, each stroke of the signature of the customer where the stroke is composed by the touch points detected by the touchscreen 21 as the signing operation is being performed. That is to say, as the customer is signing the signature on the signing area of the touchscreen 21, the detecting signals are simultaneously being generated by the touchscreen 21 according to the touch points that are detected, and each stroke of the signature is displayed on the touchscreen 21, where the customer is able to see, in real time, the signature that is being signed on the signing area of the touchscreen 21.

In step S03, the processing module 22 generates signature data based on the detecting signals that are generated by the touchscreen 21. Specifically, the processing module 22 generates the signature data after the customer has completed the signing operation. In some embodiments, the processing module 22 further controls the touchscreen 21 to display a confirm button outside of the signing area. After the customer has performed the signing operation, the customer may click (i.e., by making contact using the fingertip or the stylus pen) on the confirm button, and the touchscreen 21 will generate a confirm signal that corresponds to the confirm button. In response to receipt of the confirm signal that corresponds to the confirm button, the processing module 22 determines that the signing operation is completed, and the processing module 22 then generates the signature data that represents the signature of the customer.

In step S04, the processing module 22 transmits the signature data to the POS terminal 1.

With the abovementioned configuration, the POS system 100 may display the purchase information of the customer through the customer display 2 so that the customer may view the purchase information of the purchase to be made. In addition, the POS system 100 may obtain the signature that is handwritten by the customer without the need to connect to an additional signature pad. Therefore, a merchant may save the cost of purchasing the additional signature pad, and the cost of managing and maintaining the additional signature pad. For a manufacturer of a POS system 100, since the customer display 2 is configured to acquire the signature of the customer and the POS terminal 1 is able to obtain the signature data, the manufacturer does not need to develop new models of POS terminals, thereby facilitating more efficient inventory management of the POS terminals of the manufacturer.

In summary, the customer display 2 of the POS system 100 includes the touchscreen 21, and the processing module 22 that controls the touchscreen 21 to display the signing area for the customer to perform the signing operation thereon, that controls the touchscreen 21 to detect the touch points and to generate the detecting signals based on the touch points, that generates signature data based on the detecting signals generated by the touchscreen 21, and that transmits the signature data to the POS terminal 1. Therefore, by virtue of the customer display 2 being able to be used to acquire the signature of the customer, there is no need to connect the POS terminal 1 to an additional signature pad.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A point of sale (POS) system for acquiring a signature of a customer, comprising:
a POS terminal; and
a customer display including a touchscreen, and a processing module that is electrically connected to said touchscreen and said POS terminal, said processing module being configured to
control said touchscreen to display a signing area on said touchscreen during a signature acquisition procedure for acquiring a signature of the customer, and control said touchscreen to allow the customer to perform a signing operation on said signing area,
control said touchscreen to detect touch points on said touchscreen and to generate multiple detecting signals that are related respectively to the touch points as the signing operation is being performed by the customer on said signing area of said touchscreen,
generate signature data based on the detecting signals that are generated by said touchscreen during the signature acquisition procedure, and
transmit the signature data to said POS terminal.

2. The POS system as claimed in claim 1, wherein said processing module is further configured to, based on the detecting signals, control said touchscreen to display in real time, a stroke of the signature that is composed by the touch points detected by said touchscreen as the signing operation is being performed on said signing area of said touchscreen.

3. The POS system as claimed in claim 1, wherein said POS terminal is configured to transmit purchase information that is related to a purchase to be made by the customer to said processing module, and said processing module is further configured to, in response to receipt of the purchase information from said POS terminal, control said touchscreen to display the purchase information on said touchscreen.

4. The POS system as claimed in claim 3, wherein the purchase information includes a name of a good, a unit price of the good, and a total price for the purchase to be made by the customer.

5. A customer display to be used in a POS system for acquiring a signature of a customer, the POS system including a POS terminal, said customer display comprising:
a touchscreen; and
a processing module that is electrically connected to said touchscreen and that is adapted to be electrically connected to the POS terminal, said processing module being configured to
control said touchscreen to display a signing area on said touchscreen during a signature acquisition procedure for acquiring a signature of the customer, and control said touchscreen to allow the customer to perform a signing operation on said signing area,
control said touchscreen to detect touch points on said touchscreen and to generate multiple detecting signals that are related respectively to the touch points as the signing operation is being performed by the customer on said signing area of said touchscreen,
generate signature data based on the detecting signals that are generated by said touchscreen during the signature acquisition procedure, and
transmit the signature data to the POS terminal.

6. The customer display as claimed in claim 5, wherein said processing module is further configured to, based on the detecting signals, control said touchscreen to display in real time, a stroke of the signature that is composed by the touch points detected by said touchscreen as the signing operation is being performed on said signing area of said touchscreen.

7. The customer display as claimed in claim 5, wherein said processing module is further configured to, in response to receipt of purchase information from the POS terminal, control said touchscreen to display the purchase information on said touchscreen, the purchase information being related to a purchase to be made by the customer.

8. The customer display as claimed in claim 7, wherein the purchase information includes a name of a good, a unit price of the good, and a total price for the purchase to be made by the customer.

9. A method for acquiring a signature of a customer, the method to be implemented by a POS system that includes a POS terminal and a customer display, the customer display including a touchscreen and a processing module, the method comprising:
the processing module controlling the touchscreen to display a signing area on the touchscreen during a signature acquisition procedure for acquiring a signature of the customer, and controlling the touchscreen to allow the customer to perform a signing operation on the signing area;
the processing module controlling the touchscreen to detect touch points on the touchscreen and to generate multiple detecting signals that are related respectively to the touch points as the signing operation is being performed by the customer on the signing area of the touchscreen;
the processing module generating signature data based on the detecting signals that are generated by the touchscreen during the signature acquisition procedure; and
the processing module transmitting the signature data to the POS terminal.

10. The method as claimed in claim 9, further comprising:
the processing module controlling, based on the detecting signals, the touchscreen to display in real time, a stroke of the signature that is composed by the touch points detected by the touchscreen as the signing operation is being performed on the signing area of the touchscreen.
